(19) United States
(12) Patent Application Publication
(10) Pub. No.: US 2010/0009584 A1
(43) Pub. Date: Jan. 14, 2010

(54) ADHESION ACTIVATOR INTENDED FOR APPLICATION TO A THERMOPLASTIC POLYMER ELASTOMER SUBSTRATE OR PA SUBSTRATE, AND METHODS OF SURFACE TREATMENT AND OF ASSEMBLY BY CORRESPONDING ADHESIVE BONDING

(75) Inventors: Bruno D'Herbecourt, Bernay (FR); Rene-Paul Eustache, Combon (FR); Thierry Badel, Lyon (FR)

Correspondence Address: ARKEMA INC.;PATENT DEPARTMENT - 26TH FLOOR, 2000 MARKET STREET, PHILADELPHIA, PA, 19103-3222, US

(73) Assignee: Akema France, Columbes (FR)

(21) Appl. No.: 12/302,198

(22) PCT Filed: Jul. 6, 2007
(86) PCT No.: PCT/FR2007/051609

§ 371 Date: Sep. 18, 2009

Related U.S. Application Data
(60) Provisional application No. 60/841,658, filed on Aug. 31, 2006.

(30) Foreign Application Priority Data
Jul. 7, 2006 (FR) 0652686

(51) Int. Cl. B32B 27/08; B32B 27/34; B32B 27/32; B32B 27/36; B32B 27/40; B32B 5/02

(52) U.S. Cl. 442/179; 428/474.4; 428/476.9; 428/523; 428/475.2; 428/480; 428/412; 428/423.1; 428/423.5; 428/476.3; 428/521; 442/180; 428/473; 428/537.5

(57) ABSTRACT

The present invention relates to the assembly by adhesive bonding of a first substrate S1 made of thermoplastic polymer elastomer (abbreviation TPE) or of omopolymeric polyamide (abbreviation PA) or copolymeric polyamide (abbreviation coPA) and of a second substrate S2. The substrates S1 and S2 can be of the same kind, in other words made of TPE or of homopolymeric PA or of coPA, or may be of different kinds. Generally speaking, the thermoplastic polymer elastomer (TPE) substrates S1 are assembled by adhesive bonding with other substrates S2 by means of adhesives or glues based on organic solvent, which are also referred to as two-component solvent-borne polyurethane adhesives.

The present invention relates to the adhesive joining of a first substrate S1 made of thermoplastic elastomer (abbreviation TPE) polymer or of polyamide (abbreviation PA) homo- or copolymer (abbreviation coPA) and of a second substrate S2. The substrates S1 and S2 can be of the same nature, that is to say made of TPE or of PA homo- or coPA, or can be different in nature.

Silicones are positively excluded from the substrates (S1) and (S2).

Document WO/14146 relates to the bonding of a silicone material. This bonding is improved by treating the surface of said silicone so as to change the character of the surface of said material. The treatment consists in at least partially functionalizing the surface of the material with chemically reactive functional groups, for example hydroxyl or carboxyl functional groups or both of these groups. The treatments suitable for creating such a functionalization include (i) irradiation of the surface of the material with an effective dose of electromagnetic radiation, for example ultraviolet, infrared or visible radiation, and (ii) bringing the surface of the material into contact with various oxidizing reagents which may be in gas, liquid or plasma form, such as oxygen, ozone, peroxides, oxygen/fluorine (O2/F2) mixtures, air/fluorine mixtures, fluorine mixtures, peroxide acids and similar products.

Document EP 456 972 relates to polyimides and not to TPEs or PAs. The polyimide surface is functionalized by opening the imide functional groups onto which carboxyl functional groups are branched which may then be combined with metal complexes.

These documents are very different from this invention in so far as, in this case:
the functional groups already exist on the TPE or PA polymer. No new functionality is created on the TPE or PA substrate; and
the objective of the adhesion activator is to make these existing functional groups accessible and to accelerate their reactivity with isocyanates, in particular the isocyanates present in adhesives and/or aqueous primers.

Generally, substrates (S1) made of thermoplastic elastomer (TPE) polymer are adhesively joined with other substrates (S2) using adhesives comprising an organic solvent, also referred to as solvent adhesives, of two-component polyurethane type.

The adhesive bonding of this type of substrate (S1) to substrates (S2) requires the following operations, in order:

cleaning the surfaces of the substrates (S1) and (S2) to be adhesively bonded with an organic solvent, such as methyl ethyl ketone (MEK);

applying, generally with a brush, a layer of primer composition, generally a solvent-comprising composition, to at least the conjoining surface of the substrate (S1) made of polyamide-block-polyether copolymer;

drying the primer layer in an oven;

applying, generally with a brush, a layer of two-component adhesive to the primer layer and also to the conjoining surface of the other substrate (S2);

drying the layers of adhesive in an oven;

joining together the two adhesive-coated substrates (S1) and (S2); and

pressurizing the combination resulting from the joining together process.

The primer compositions used are generally two-component compositions, the first component of which is solution of a functionalized resin in an organic solvent and the second component (crosslinking agent) of which, which is added to the first component immediately before use, is an isocyanate or a mixture of isocyanates, also in solution in an organic solvent. This stage of applying the primer thus involves emissions of organic solvents into the atmosphere.

Two-component adhesives comprise a first component, which is a hydroxylated organic resin in dispersion or solution in an organic solvent and/or in water, and a second component (crosslinking agent), which is a solution of isocyanate in an organic solvent or a pure isocyanate. In the case of an organic solvent adhesive, a further emission of solvent is generated.

During these various stages (the stage of applying the primer and/or the adhesive, and the drying stage), it has been calculated that approximately 30 kg of organic solvents originating from the use of a primer and of an adhesive based on solvents are emitted during the assembling of 10 000 shoes, hence the many problems in terms of atmospheric pollution and of toxicity but also as regards additional cost.

The present invention is targeted at overcoming these disadvantages and at providing simple and effective means for enhancing the adhesion of the adhesively joined substrates (S1) and (S2) defined below.

The present invention thus relates to the use of an adhesion activator and/or a mixture of adhesion activators (A) on the surface of a substrate (S1) made of thermoplastic elastomer (TPE) polymer comprising chains formed of an alternation of hard segments and of soft segments or made of PA homo- or coPA, for the purpose of the adhesive joining of the said substrate (S1) to another substrate (S2). The increase in the adhesion is obtained by the presence of an and/or of a mixture of adhesion activators (A) at the surface (F1) of the substrate (S1) and/or at the interface between the substrate (S1) and the adhesion primer (P), in the case of adhesive bonding with primer, or between the substrate (S1) and the adhesive (C), in the case of adhesive bonding without primer (P).

The invention relates to the use of an adhesion activator (A) intended (i) to react with the functional groups of at least one polymer of a substrate (S1) and/or (ii) to complex the chains of at least one polymer of the said substrate (S1), at an adhesive-bonding surface (F1) of a substrate (S1) comprising at least one thermoplastic elastomer (TPE) polymer, which comprises a chain formed of an alternation of hard segments and of soft segments, or at least one polyamide homo- or copolymer, for the purpose of the adhesive joining of the said substrate (S1) to another substrate (S2).

According to one embodiment, the use is characterized in that the adhesion activator (A) is chosen from the catalysts which play a role in the chemical reactions involving isocyanate functional groups.

According to one embodiment, the use is characterized in that the adhesion activator (A) is chosen from catalysts of amine type, of metal salts type, of organometallic type and their mixtures.

According to one embodiment, the use is characterized in that the substrate (S2) is of the same nature as (S1).

According to one embodiment, the use is characterized in that the substrate (S1) and the substrate (S2) are different in nature, such that (S2) is chosen from (TPEs), homopolymers and copolymers, such as polyolefins, polyamines, polyesters, polyethers, polyesterethers, polyimides, polycarbonates, phenolic resins, polyurethanes, which may or may not be crosslinked, in particular foams, poly(ethylene/vinyl acetate)s, natural or synthetic elastomers, such as polybutadienes, polyisoprenes, styrene/butadiene/styrenes (SBSs), styrene/butadiene/acrylonitriles (SBNs), polyacrylonitriles, natural or synthetic fabrics, in particular fabrics made of organic polymer fibres, such as fabrics made of polypropylene, polyethylene, polyesters, poly(vinyl alcohol), poly(vinyl acetate), poly(vinyl chloride) or polyamide fibres, fabrics made of glass fibres or of carbon fibres, and materials such as leather, paper and board.

According to one embodiment, the use is characterized in that the substrate (S1) is chosen from (a) copolymers comprising polyester blocks and polyether blocks, (b) copolymers comprising polyurethane blocks and polyether blocks, (c) copolymers comprising polyamide blocks and polyether blocks, and their blends.

The invention also relates to a process for the surface treatment of a substrate (S1) made of thermoplastic elastomer (TPE) polymer or of polyamide homo- or copolymer in order to promote the attachment of a primer and/or of an adhesive to an adhesive-bonding surface (F1) of the said substrate (S1) for the purpose of the adhesive joining of the said substrate (S1) to another substrate (S2), characterized in that an adhesion activator (A) is included in the polymer forming the substrate (S1).

According to one embodiment, the process for the surface treatment of a substrate (S1) made of thermoplastic elastomer (TPE) polymer or made of polyamide homo- or copolymer in order to promote the attachment of a primer (P) and/or of an adhesive (C) for the purpose of the adhesive joining of the said substrate (S1) to another substrate (S2) is characterized in that an adhesion activator (A) is applied to the substrate (S1).

According to one embodiment, the process for the surface treatment of a substrate (S1) is characterized in that the adhesion activator (A) is included in a mixture comprising at least one cleaning solvent which is applied to the adhesive-bonding surface (F1) of the substrate (S1) for the purpose of the adhesive joining of the said substrate (S1) to another substrate (S2).

According to one embodiment, the process for the surface treatment of a substrate (S1) is characterized in that the adhesion activator (A) is included in a layer of adhesion primer (P) which is applied to the adhesive-bonding surface (F1) of the substrate (S1) for the purpose of the adhesive joining of the said substrate (S1) to another substrate (S2).

According to one embodiment, the process for the surface treatment of a substrate (S1) is characterized in that the adhesion activator (A) is included in a layer of adhesive (C) which is applied to the adhesive-bonding surface (F1) of the substrate (S1) for the purpose of the adhesive joining of the said substrate (S1) to another substrate (S2).

According to one embodiment, the process is characterized in that the adhesion activator (A), alone or mixed with a degreasing solvent and/or with an adhesion primer (P) and/or with an adhesive (C), is applied to the adhesive-bonding surface (F1) of the substrate (S1).

According to one embodiment, the process is characterized in that use is made of a solvent-based or water-based adhesion primer (A).

According to one embodiment, the process for the adhesive joining of a substrate (S1) made of thermoplastic elastomer (TPE) polymer or made of polyamide homo- or copolymer to a substrate (S2) is characterized in that an adhesive-bonding surface (F1) of the substrate (S1) is treated by the process as defined above and in that the two substrates (S1) and (S2) are joined via their two adhesive-bonding surfaces (F1) and (F2), at least one of which has been adhesive-coated.

The invention also relates to an adhesively bonded assembly of two substrates (S1) and (S2), in particular a shoe sole comprising two layers of substrate (S1) and (S2), at least one being a thermoplastic elastomer (TPE) polymer or a polyamide homo- or copolymer which has been activated by an adhesion activator (A) as defined above.

According to one embodiment, the adhesively bonded assembly of two substrates (S1) and (S2) is obtained according to the joining process defined above.

The invention also relates to a kit for the adhesive joining of a substrate (S1) made of thermoplastic elastomer polymer or made of polyamide homo- or copolymer to another substrate (S2), comprising:

a. an adhesion activator (A) as defined above, and
b. optionally an adhesion primer (P), and
c. an adhesive (C) intended for the adhesive coating of the substrate (S1), and comprising:

optionally an adhesion primer (P), and

an adhesive (C) intended for the adhesive coating of the substrate (S2).

The structure of FIG. 1 represents a substrate (S1) adhesively bonded at its surface (F1) to a substrate (S2) at its surface (F2) via an adhesive (C) and an adhesion activator according to the invention.

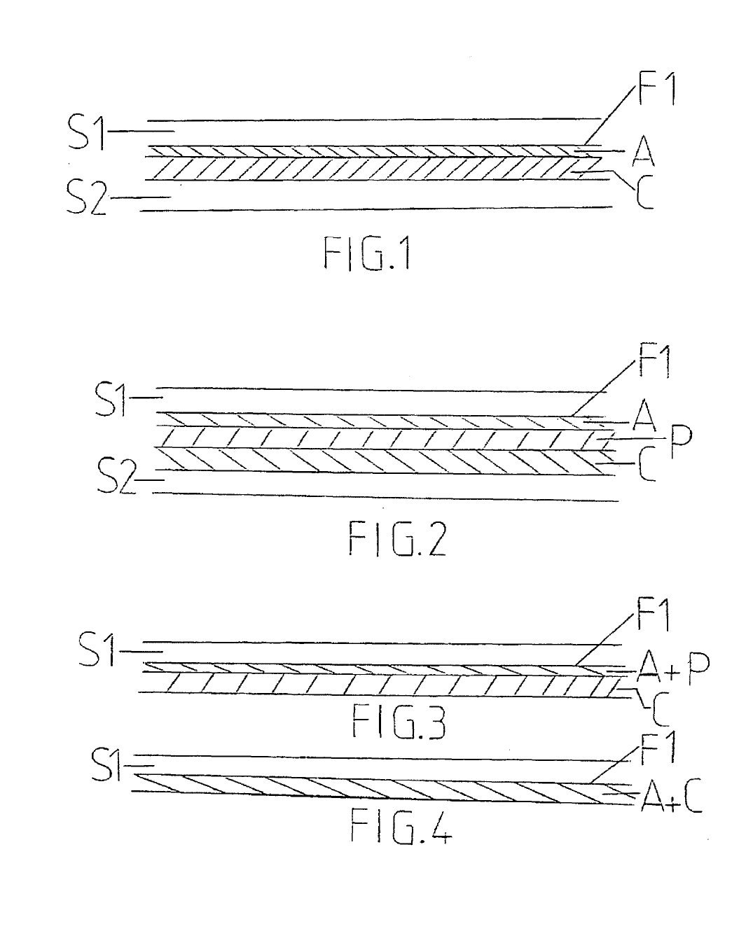

The structure of FIG. 2 additionally comprises an adhesion primer between the adhesion activator (A) and the adhesive (C).

FIGS. 3 and 4 represent embodiments of the invention in which the structures comprise adhesion activator (A) in their layer of primer (P) or in their layer of adhesive (C).

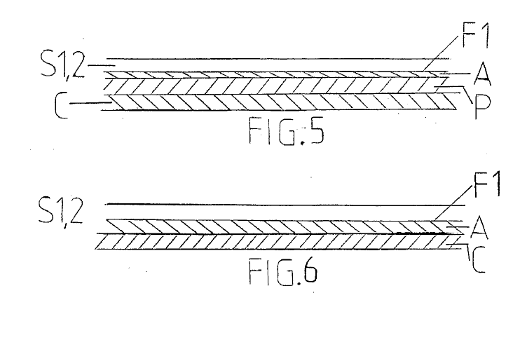

FIGS. 5 and 6 represent an adhesive-coated substrate S1 or S2 before conjoining, with or without primer.

The term “thermoplastic elastomer (TPE) polymer” is understood to mean a block copolymer comprising, alternately, blocks or segments referred to as hard or rigid and blocks or segments referred to as soft or flexible.

Mention may be made, by way of examples of copolymers comprising hard blocks and comprising soft blocks, of respectively (a) copolymers comprising polyester blocks and polyether blocks (also known as polyetheresters), (b) copolymers comprising polyurethane blocks and polyether blocks (also known as TPUs, abbreviation for thermoplastic polyurethanes) and (c) copolymers comprising polyamide blocks and polyether blocks (also known as PEBAs according to the IUPAC).

As regards the polyetheresters (a), these are copolymers comprising polyester blocks and polyether blocks. They are composed of soft polyether blocks, which are the residues of polyether diols, and of rigid segments (polyester blocks), which result from the reaction of at least one dicarboxylic acid with at least one short chain-extending diol unit. The polyester blocks and the polyether blocks are connected via ester bonds resulting from the reaction of the acid functional groups of the acid with the OH functional groups of the polyether diol. The short chain-extending diol can be chosen from the group consisting of neopentyl glycol, cyclohexanedimethanol and aliphatic glycols of the formula HO(CH₂)ₙOH in which n is an integer with a value from 2 to 10.

Advantageously, the diacids are aromatic dicarboxylic acids having from 8 to 14 carbon atoms. Up to 50 mol % of the aromatic dicarboxylic acid can be replaced by at least one other aromatic dicarboxylic acid having from 8 to 14 carbon atoms and/or up to 20 mol % can be replaced by an aliphatic dicarboxylic acid having from 2 to 12 carbon atoms.

Mention may be made, as examples of aromatic dicarboxylic acids, of terephthalic acid, isophthalic acid, bibenzoic acid, naphthalenedicarboxylic acid, 4,4′-diphenylenedicarboxylic acid, bis(p-carboxyphenyl)methane, ethylenebis(p-benzoic acid), 1,4-tetramethylenebis(p-oxybenzoic acid), ethylenebis(para-oxybenzoic acid) and 1,3-trimethylenebis(p-oxybenzoic acid).

Mention may be made, as examples of glycols, of ethylene glycol, 1,3-trimethylene glycol, 1,4-tetramethylene glycol, 1,6-hexamethylene glycol, 1,3-propylene glycol, 1,8-octamethylene glycol, 1,10-decamethylene glycol and 1,4-cyclohexylenedimethanol. The copolymers comprising polyester blocks and polyether blocks are, for example, copolymers having polyether units derived from polyether diols, such as polyethylene glycol (PEG), polypropylene glycol (PPG), polytrimethylene ether glycol (PO3G) or polytetramethylene glycol (PTMG), dicarboxylic acid units, such as terephthalic acid, and glycol (ethanediol) or 1,4-butanediol units. The linking of the polyethers and of the diacids forms the soft segments whereas the linking of the glycol or of the butanediol with the diacids forms the rigid segments of the copolyetherester. Such copolyetheresters are disclosed in the patents EP 402 883 and EP 405 227. These polyetheresters are thermoplastic elastomers. They can comprise plasticizers.

As regards the TPUs (b), they result from the condensation of soft polyether blocks, which are residues of polyetherdiols, and of rigid polyurethane blocks resulting from the reaction of at least one diisocyanate with at least one short diol. The short chain-extending diol can be chosen from the glycols mentioned above in the description of the polyetheresters. The polyurethane blocks and the polyether blocks are connected via bonds resulting from the reaction of the isocyanate functional groups with the OH functional groups of the polyetherdiol.

Mention may also be made of polyesterurethanes, for example those comprising diisocyanate units, units derived from amorphous polyester diols and units derived from a short chain-extending diol. They can comprise plasticizers.

As regards the PEBAs (c), they result from the copolycondensation of polyamide sequences comprising reactive ends with polyether sequences comprising reactive ends, such as, inter alia:
1) Polyamide sequences comprising diamine chain ends with polyoxyalkylene sequences comprising dicarboxyl chain ends.
2) Polyamide sequences comprising dicarboxyl chain ends with polyoxyalkylene sequences comprising diamine chain ends obtained by cyanoethylation and hydrogenation of aliphatic α,ω-dihydroxylated polyoxyalkylene sequences, referred to as polyether diols.
3) Polyamide sequences comprising dicarboxyl chain ends with polyether diols, the products obtained being, in this specific case, polyetheresteramides. The copolymers of the invention are advantageously of this type.

The polyamide sequences comprising dicarboxyl chain ends originate, for example, from the condensation of precursors of polyamides in the presence of a chain-limiting dicarboxylic acid.

The polyamide sequences comprising diamine chain ends originate, for example, from the condensation of precursors of polyamides in the presence of a chain-limiting diamine.

The polymers comprising polyamide blocks and polyether blocks can also comprise units distributed randomly. These polymers can be prepared by the simultaneous reaction of the polyether and of the precursors of the polyamide blocks.

For example, polyether diol, polyamide precursors and a chain-limiting diacid can be reacted. A polymer is obtained which has essentially polyether blocks and polyamide blocks of highly variable length, but also the various reactants which have reacted randomly and which are distributed randomly (statistically) along the polymer chain.

Polyether diamine, polyamide precursors and a chain-limiting diacid can also be reacted. A polymer is obtained which has essentially polyether blocks and polyamide blocks of highly variable length, but also the various reactants which have reacted randomly and which are distributed randomly (statistically) along the polymer chain.

Use may advantageously be made of three types of polyamide blocks.
According to a first type, the polyamide sequences originate from the condensation of a dicarboxylic acid, in particular those having from 4 to 20 carbon atoms, preferably those having from 6 to 18 carbon atoms, and of an aliphatic or aromatic diamine, in particular those having from 2 to 20 carbon atoms, preferably those having from 6 to 14 carbon atoms.

Mention may be made, as examples of dicarboxylic acids, of 1,4-cyclohexanedicarboxylic acid, butanedioic acid, adipic acid, azelaic acid, suberic acid, sebacic acid, dodecanedicarboxylic acid, octadecanedicarboxylic acid, terephthalic acid and isophthalic acid, but also dimerized fatty acids.

Mention may be made, as examples of diamines, of tetramethylenediamine, hexamethylenediamine, 1,10-decamethylenediamine, dodecamethylenediamine, trimethylhexamethylenediamine, the isomers of bis(4-aminocyclohexyl)methane (BACM), bis(3-methyl-4-aminocyclohexyl)methane (BMACM) and 2-2-bis(3-methyl-4-aminocyclohexyl)propane (BMACP), and para-amino-dicyclohexylmethane (PACM), and isophoronediamine (IPDA), 2,6-bis(aminomethyl)norbornane (BAMN) and piperazine (Pip).

Advantageously, PA 4.12, PA 4.14, PA 4.18, PA 6.10, PA 6.12, PA 6.14, PA 6.18, PA 9.12, PA 10.10, PA 10.12, PA 10.14 and PA 10.18 blocks are available.
According to a second type, the polyamide sequences result from the condensation of one or more α,ω-aminocarboxylic acids and/or of one or more lactams having from 6 to 12 carbon atoms in the presence of a dicarboxylic acid having from 4 to 12 carbon atoms or of a diamine.

Mention may be made, as examples of lactams, of caprolactam, oenantholactam and lauryllactam.

Mention may be made, as examples of α,ω-aminocarboxylic acids, of aminocaproic acid, 7-aminoheptanoic acid, 11-aminoundecanoic acid and 12-aminododecanoic acid.

Advantageously, the polyamide blocks of the second type are made of polyamide 12 or of polyamide 6.
According to a third type, the polyamide sequences result from the condensation of at least one α,ω-aminocarboxylic acid (or one lactam), at least one diamine and at least one dicarboxylic acid.

In this case, during a first stage, the polyamide PA blocks are prepared by polycondensation:
of the linear or aromatic aliphatic diamine or diamines having X carbon atoms;
of the dicarboxylic acid or acids having Y carbon atoms; and
of the comonomer or comonomers {Z}, chosen from lactams and α,ω-aminocarboxylic acids having Z carbon atoms and equimolar mixtures of at least one diamine having X1 carbon atoms and of at least one dicarboxylic acid having Y1 carbon atoms, (X1, Y1) being different from (X, Y),
the said comonomer or comonomers {Z} being introduced in a proportion by weight ranging up to 50%, preferably up to 20%, more advantageously still up to 10%, with respect to the combined polyamide precursor monomers;
in the presence of a chain-limiting agent chosen from dicarboxylic acids; then during a second stage, the polyamide PA blocks obtained are reacted with polyether PE blocks in the presence of a catalyst.

Advantageously, use is made, as chain-limiting agent, of the dicarboxylic acid having Y carbon atoms, which is introduced in excess with respect to the stoichiometry of the diamine or diamines.

Preferably, the polycondensation is carried out at a temperature of 180 to 300° C.

The catalyst is defined as being any product which makes it possible to facilitate the bonding of the polyamide blocks and polyether blocks by esterification or by amidation. The esterification catalyst is advantageously a derivative of a metal chosen from the group formed by titanium, zirconium and hafnium or else a strong acid, such as phosphoric acid or boric acid. Examples of catalysts are those disclosed in U.S. Pat. Nos. 4,331,786, 4,115,475, 4,195,015, 4,839,441, 4,864,014, 4,230,838 and 4,332,920.

The general method for the two-stage preparation of PEBA copolymers having ester bonds between the PA blocks and the PE blocks is known and is disclosed, for example, in French Patent FR 2 846 332. The general method for the preparation of the PEBA copolymers of the invention having amide bonds between the PA blocks and the PE blocks is known and disclosed, for example, European Patent EP 1 482 011.

The reaction for the formation of PA block usually takes place between 180 and 300° C., preferably from 200 to 290° C., the pressure in the reactor becomes established between 5 and 30 bars and is maintained for approximately 2 to 3 hours. The pressure is slowly reduced, the reactor being brought to atmospheric pressure, and then the excess water is distilled off, for example over one or two hours.

The polyamide comprising carboxylic acid ends having been prepared, the polyether and a catalyst are subsequently added. The polyether can be added all at once or a little at a time, and likewise for the catalyst. According to an advantageous form, first the polyether is added and the reaction of the OH ends of the polyether and of the COOH ends of the polyamide begins with formation of ester bonds and removal of water. As much as possible of the water is removed from the reaction medium by distillation and then the catalyst is introduced in order to complete the bonding of the polyamide blocks and polyether blocks. This second stage is carried out with stirring, preferably under a vacuum of at least 6 mmHg (800 Pa), at a temperature such that the reactants and the copolymers obtained are in the molten state. By way of example, this temperature can be between 100 and 400° C. and generally 200 and 300° C. The reaction is monitored by the measurement of the torque exerted by the molten polymer on the stirrer or by the measurement of the electric power consumed by the stirrer. The end of the reaction is determined by the target value of the torque or of the power.

It will also be possible to add, during the synthesis, at the moment judged most opportune, one or more molecules used as antioxidant, for example Irganox® 1010 or Irganox® 245.

According to an alternative form of this third type, the polyamide blocks result from the condensation of at least two α,ω-aminocarboxylic acids or of at least two lactams having from 6 to 12 carbon atoms or of a lactam and of an aminocarboxylic acid not having the same number of carbon atoms in the possible presence of a chain-limiting agent.

Mention may be made, as examples of aliphatic α,ω-aminocarboxylic acids, of aminocaproic acid, 7-aminoheptanoic acid, 11-aminoundecanoic acid and 12-aminododecanoic acid.

Mention may be made, as examples of lactams, of caprolactam, oenantholactam and lauryllactam.

Mention may be made, as examples of aliphatic diamines, of hexa-methylenediamine, dodecamethylenediamine and trimethylhexamethylene diamine.

Mention may be made, as examples of cycloaliphatic diacids, of 1,4-cyclohexanedicarboxylic acid.

Mention may be made, as examples of aliphatic diacids, of butanedioic acid, adipic acid, azelaic acid, suberic acid, sebacic acid, dodecanedicarboxylic acid, dimerized fatty acids (these dimerized fatty acids preferably have a dimer content of at least 98%; preferably they are hydrogenated; they are sold under the “Pripol” trademark by “Unichema”, or under the Empol trademark by Henkel) and polyoxyalkylene-α,ωdiacids.

Mention may be made, as examples of aromatic diacids, of terephthalic acid (T) and isophthalic acid (I).

Mention may be made, as examples of cycloaliphatic diamines, of the isomers of bis(4-aminocyclohexyl)methane (BACM), bis(3-methyl-4-aminocyclohexyl)methane (BMACM) and 2-2-bis(3-methyl-4-aminocyclohexyl)propane (BMACP), and para-amino-dicyclohexylmethane (PACM). The other diamines commonly used can be isophoronediamine (IPDA), 2,6-bis(aminomethyl)norbornane (BAMN) and piperazine.

Mention may be made, as examples of polyamide sequences of the third type, of the following:

6.6/6
6.6 denotes hexamethylenediamine units condensed with adipic acid.
6 denotes units resulting from the condensation of caprolactam.

6.6/Pip.10/12, in which
6.6 denotes hexamethylenediamine units condensed with adipic acid.
Pip.10 denotes units resulting from the condensation of piperazine and of sebacic acid.
12 denotes units resulting from the condensation of lauryllactam.
The proportions by weight are respectively 25 to 35/20 to 30/20 to 30, the total being 80, and advantageously 30 to 35/22 to 27/22 to 27, the total being 80.
For example, the proportions 32/24/24 result in a melting temperature of 122 to 137° C.

6.6/6.10/11/12 in which
6.6 denotes hexamethylenediamine condensed with adipic acid.
6.10 denotes hexamethylenediamine condensed with sebacic acid.
11 denotes units resulting from the condensation of aminoundecanoic acid.
12 denotes units resulting from the condensation of lauryllactam.
The proportions by weight are respectively 10 to 20/15 to 25/10 to 20/15 to 25, the total being 70, and advantageously 12 to 16/18 to 25/12 to 16/18 to 25, the total being 70.
For example, the proportions 14/21/14/21 result in a melting temperature of 119 to 131° C.

The polyamide blocks are obtained in the presence of a chain-limiting diacid or diamine if polyamide blocks comprising acid or amine ends are desired. If the precursors already comprise a diacid or a diamine, it is sufficient, for example, to use it in excess.

The polyether blocks can represent 5 to 85% by weight of the copolymer comprising polyamide and polyether blocks. The polyether blocks are composed of alkylene oxide units. These units can, for example, be ethylene oxide units, propylene oxide units or tetrahydrofuran units (which results in polytetramethylene glycol linkages). Use is thus made of PEG blocks, that is to say those composed of ethylene oxide units, of PPG blocks, that is to say those composed of propylene oxide units, of polytrimethylene ether glycol blocks (such copolymers with polytrimethylene ether blocks are disclosed in U.S. Pat. No. 6,590,065) and of PTMG blocks, that is to say those composed of tetramethyleneglycol units, also referred to as polytetrahydrofuran blocks. Use is advantageously made of PEG blocks or of blocks obtained by oxyethylation of bisphenols, such as, for example, bisphenol A. The latter products are disclosed in Patent EP 613 919.

The polyether blocks can also be composed of ethoxylated primary amines. Use is also advantageously made of these blocks. Mention may be made, as examples of ethoxylated primary amines, of the products of formula:

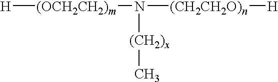

in which m and n are between 1 and 20 and x is between 8 and 18. These products are available commercially under the Noramox® trademark from Ceca and under the Genamin® trademark from Clariant.

The amount of polyether blocks in these copolymers comprising polyamide blocks and polyether blocks is advantageously from 10 to 70% by weight of the copolymer and preferably from 35 to 60%.

The polyether diol blocks are either used as is and copolycondensed with polyamide blocks comprising carboxyl ends or they are aminated, in order to be converted to polyether diamines, and condensed with polyamide blocks comprising carboxyl ends. They can also be blended with polyamide precursors and a chain-limiting diacid to produce polymers comprising polyamide blocks and polyether blocks having units which are distributed randomly.

The number-average molar mass M̅n̅ of the polyamide sequences is between 500 and 10 000 and preferably between 500 and 4000, except for the polyamide blocks of the second type. The mass M̅n̅ of the polyether sequences is between 100 and 6000 and preferably between 200 and 3000.

These polymers comprising polyamide blocks and polyether blocks, whether they originate from the copolycondensation of polyamide and polyether sequences prepared beforehand or from a single-stage reaction, exhibit, for example, an intrinsic viscosity between 0.8 and 2.5, measured in meta-cresol at 25° C., for an initial concentration of 0.8 g/100 ml.

As regards the preparation of the copolymers comprising polyamide blocks and polyether blocks, they can be prepared by any means which makes it possible to attach polyamide blocks and polyether blocks. In practice, essentially two processes are used, one a two-stage process and the other a single-stage process. In the two-stage process, first the polyamide blocks are manufactured and then, in the second stage, the polyamide blocks and the polyether blocks are attached. In the single-stage process, the polyamide precursors, the chain-limiting agent and the polyether are blended; a polymer is then obtained which has essentially polyether blocks and polyamide blocks of highly variable length, but also the various reactants which have reacted randomly and which are distributed randomly (statistically) along the polymer chain. Whether in a single stage or two stages, it is advantageous to carry out the reaction in the presence of a catalyst. Use may be made of the catalysts disclosed in U.S. Pat. Nos. 4,331,786, 4,115,475, 4,195,015, 4,839,441, 4,864,014, 4,230,838 and 4,332,920, WO 04/037898, EP 1 262 527, EP 1 270 211, EP 1 136 512, EP 1 046 675, EP 1 057 870, EP 1 155 065, EP 506 495 and EP 504 058. In the single-stage process, polyamide blocks are also manufactured; this is why it was said at the beginning of this paragraph that these copolymers could be prepared by any means for attaching polyamide blocks (PA blocks) and polyether blocks (PE blocks).

Advantageously, the PEBA copolymers have PA blocks made of PA 6, PA 12, PA 6.6/6, PA 10.10 and PA 6.14 and PE blocks made of PTMG, PPG, PO3G and PEG.

S1 is chosen from the TPEs defined above and polyamide homo- and copolymers. S1 and S2 can be identical or different but, in this case, S2 is chosen from the TPEs defined above, homopolymers and copolymers, such as polyolefins, polyamines, polyesters, polyethers, polyesterethers, polyimides, polycarbonates, phenolic resins, polyurethanes, which may or may not be crosslinked, in particular foams, poly(ethylene/vinyl acetate)s, natural or synthetic elastomers, such as polybutadienes, polyisoprenes, styrene/butadiene/styrenes (SBSs), styrene/butadiene/acrylonitriles (SBNs), polyacrylonitriles, natural or synthetic fabrics, in particular fabrics made of organic polymer fibres, such as fabrics made of polypropylene, polyethylene, polyesters, poly(vinyl alcohol), poly(vinyl acetate), poly(vinyl chloride) or polyamide fibres, fabrics made of glass fibres or of carbon fibres, and materials such as leather, paper and board. These materials can also all be in the foam form, when this is possible.

As regards the adhesion primer (P), it can be based on organic solvent(s) or based on water.

As regards the adhesive (C), it can be based on organic solvent(s) or based on water.

It is thus possible to have a combination of adhesion primer (P) based on solvent(s) or based on water with an adhesive (C) based on solvent(s) or based on water, bearing in mind that the adhesion activator (A) can be either:
deposited at the adhesion interface, that is to say between the substrate (S1) and the primer (P) or adhesive (C);
incorporated in the adhesion primer (P) and/or in the adhesive (C), bearing in mind that the acitvator has, in this case, to be capable of migrating to the interface between the substrate (S1) and the primer or the adhesive.

The adhesion activator (A) can be combined for the application of an adhesion primer (P) based on solvent(s) with a low adhesiveness but based on reduced volatile organic component(s) (abbreviation VOC) or based on water with an adhesive (C) based on solvent(s) or based on water.

The adhesion activators can comprise several components.

The adhesion activator (A) is advantageously chosen in order to be capable of activating the surface of the substrate (S1):
(i) by reacting with functional groups of the polymer or of at least one polymer of the substrate (S1), when the latter comprises a blend of polymers, and/or by reacting with functional groups of the primer (P) and/or the adhesive (C); and/or
(ii) by complexing the chains of the polymer or of at least one polymer of the substrate (S1), when the latter comprises a blend of polymers, and/or by complexing polymer chains of the primer (P) and/or by complexing polymer chains of the adhesive (C); and
catalysing the adhesive-bonding reaction.

The functional groups can, for example, be of the —OH, —COOH, —NH₂, ═NH, ═C═O or epoxide functional group type, the list not being exhaustive.

The adhesion activator or activators (A) can be capable of reacting under hot conditions or under cold conditions.

The adhesion activator (A) can be introduced into the cleaning solution or into the polymer by a compounding operation or using a masterblend comprising the adhesion promoter or promoters or during the polycondensation of the TPE or by incorporation by dry blending during the conversion of the moulded parts.

The adhesion activator (A) can be incorporated in the coating in contact with (S1) provided that the adhesion activator (A) can react with the polymer of (S1), the coating being defined as being the cleaning solution, the primer (P) and/or the adhesive (C). The term “adhesion interface” is used to describe the contact surface between the substrate (S1) and the coating.

The solution of incorporating the adhesion activator (A) in the cleaning solution is a preferred solution.

The cleaning solutions are those generally used to remove impurities, grease and foreign bodies which may detrimentally affect the adhesion of the primers (P) and/or adhesives (C) to the substrates.

These cleaning solutions can also comprise additives, such as wetting agents or detergents for promoting the removal of contaminants and/or for improving the wettability of the supports.

Mention may be made, for example, of cleaning solutions based on water, based on aliphatic organic solvents or based on aromatic solvents and their mixtures composed of 2 or 3 of the preceding solvents.

The main groups of solvents are:

Ketones (e.g.: acetone, methyl ethyl ketone).

Alcohols (e.g.: methanol, ethanol, isopropanol, glycols).

Esters (e.g.: acetates, plant-derived solvents).

Ethers (e.g.: ethyl ether, THF, dioxane).

Glycol ethers.

Aromatic hydrocarbons (benzene, toluene, xylene, cumene).

Petroleum solvents (aromatic-free: alkanes, alkenes).

Halogenated hydrocarbons: (chlorinated, brominated or fluorinated).

Specific solvents (amines, amides, terpenes).

The organic solvents or the solutions based on water and based on organic solvents will be carefully chosen so as to reduce as much as possible the emissions of solvents, to reduce the risks related to toxicity and to ecotoxicity and to promote good solubility of the adhesion activator and stability of the mixtures.

It has been shown that some “functional” solvents and/or mixtures of “functional” solvents act as adhesion activators (A) and make it possible to increase the adhesion of aqueous primers and/or of aqueous adhesives to supports made of thermoplastic (TPE) polymers. This is the case with butanol/butanediol mixtures. The simple presence of this type of solvent and of activator according to the invention at the interface of the substrate makes it possible to increase the level of initial adhesion and the permanence of the reactivity of this surface treatment.

By the fact that this solution makes it possible to increase the activation time of the surfaces to be coated with adhesive, this provides the assembler with greater flexibility, giving him the means for managing each stage of the joining of the pieces to be adhesively bonded and to handling and packaging thereof.

The adhesion activators (A) are chosen from the catalysts used in chemical reactions involving isocyanate functional groups. Mention may in particular be made of catalysts of amine (secondary or tertiary amine) type, of metal salt type or of organometallic type.

Mention may be made, as catalysts of amide type, for example, of diethylamine (DEA), diethanolamine, dimethylethanolamine, triethylamine (TEA), triethanolamine (TEOA), triisopropanolamine (TIPA), triethylenediamine (TEDA), dimethylaminopropylamine (DMAPA), dimethylcyclohexylamine (DMACHA), triethylenetetramide, triisopropylamine, N,N,N′,N′-tetraethylethylenediamine, N,N,N′,N′-tetramethyl-1,3-butanediamine, bis(2-dimethylaminoethyl) ether (BDMAEE), 1-(3-aminopropyl)imidazole (API), N-methylimidazole (NMI), 1,2-dimethylimidazole (DMI), imidazole, 1,4-diazobicyclo[2.2.2]octane (DABCO), N-methyl, N-ethylmorpholine.

Mention may be made, as catalysts based on metal salts, for example, of those based on: Bi, Pb, Sn, Ti, Fe, Sb, U, Cd, Co, Th, Al, Hg, Zn, Ni, R₃N, Ce, Mo, V, Mn, Zr and R₃P.

Taken in the broad sense, organometallics are characterized by the combination of bonds between metal and organic segments. Without being exhaustive, mention is made, for example, of:

dibutyltin dilaurate, tin octoate acetate, tin oleate, tin 2-ethylhexanoate, dibutyldilauryltin mercaptide, dibutyltin diacetate, lead naphthenate, zinc stearate, reaction products of tin oxide (SnO) or reaction products of dibutyltin oxide with a carboxylic acid having from 1 to 20 carbon atoms, hydrated monobutyltin oxide, butyltin chloride dihydroxide, butyltin tris(2-ethylhexanoate), butylstannic acid, dioctyltin dilaurate, dioctyltin maleate, tin oxalate, zinc carboxylates, bismuth carboxylates, organomercurous compounds, zirconium diketonates with, as diketones, 2,4-pentanedione, ethyl acetoacetate, chlorocyclopentadiene, dibenzoylmethane, 3-ethylacetylacetone, 1,1,1-trifluoroacetylacetone, dibenzoylmethane benzoylacetone, benzoylacetone, triacetylmethane, 2,2,6,6-tetramethyl-3,5-heptanedione, 6-methyl-2,4-heptanedione, 6-methyl-2,4-heptanedione, 2,4-pentanedione, 2,2-dimethyl-6,6,7,7,8,8-heptafluoro-3,5-octanedione, 6-methyl-2,4-heptanedione, 2,2-dimethyl-6,6,7,7,8,8-heptafluoro-3,5-octanedione, 6-methyl-2,4-heptanedione and butanol, 6-methyl-2,4-heptanedione and ethyl acetylacetate, 6-methyl-2,4-heptanedione and 2-acetocyclopentanone, 6-methyl-2,4-heptanedione and dibenzoylmethane and diketonates of hafnium, zirconium butoxide, molybdenum and/or tungsten with an oxidation state of at least +4, bismuth 2-ethylhexanoate, organostannic (IV) compounds, ammonium molybdate, lithium molybdate, sodium molybdate, caesium molybdate, potassium molybdate, rubidium molybdate, ammonium paramolybdate (NH₄)₆Mo₇O₂₄.4H₂O, molybdenyl bisacetylacetonate MoO₂(C₅H₇O₅)₂, molybdenum dioxide tetramethylheptanedionate MoO₂(TMHD)₂, molybdenum alkoxides formed of 1,2-, 1,3-, or 1,4-diols, such as ethylene glycol, propylene glycol or 1,4-butanediolmolybdic acid, molybdenum oxides, tetraethylammonium molybdate, sodium tungsten, magnesium molybdate, calcium molybdate, tungstic acid, lithium tungsten, phosphotungstic acid, compounds based on molybdenum and/or tungsten in the oxidation state +6, compounds based on vanadium in the oxidation state of at least +4, ammonium vanadate, lithium vanadate, sodium vanadate, potassium vanadate, lithium orthovanadate, sodium orthovanadate, potassium orthovanadate, magnesium vanadate, calcium vanadate, vanadyl(IV) acetylacetonate VO(C₅H₇O₅)₂, vanadyl bistetramethylheptanedionate VO(TMHD)₂, vanadic acid, zinc naphthenate, lead octoate, tributyltin oxide, Zr(OBu)₄, Ti(OBu)₄, cobalt naphthenate, zirconium naphthenate, Bu₂Sn(OCH₃)₂, VO(OBu)₃, Oct₂SnO, Ph₃SnOH, cobalt acetylacetonate, Al dionates, Mn dionates, Ni dionates, Co dionates, iron monocarboxylates, iron acetate, iron isobutyrate or iron trifluoroacetate.

Mention may in particular be made of Dabco T12, Fomrez SUL-4, Fascat 4202, Dabco T9, Fomrez C-2 and Cata Chek.

The adhesion activator (A) is present at 0.001 to 8% by weight, preferably from 0.001 to 4% by weight, with respect to the total weight of the medium in which it is found, namely the polymer or the coating (cleaning solution, primer and/or adhesive).

The following examples (Table 1) illustrate the present invention without, however, limiting the scope thereof. In the examples, the following abbreviations are used.

### Substrates:

5533: PEBA of PA12-PTMG (polyamide 12—polytetramethylene glycol) type, sold by Arkema under the name “PEBAX® 5533”.
7033: PEBA of PA12-PTMG (polyamide 12—polytetramethylene glycol) type, sold by Arkema under the name “PEBAX® 7033”.
PEBAX® 7033 is harder than PEBAX® 5533.

### Solvent:

MEK: methyl ethyl ketone

### Primers:

W104: water-based primer sold by Dongsung under the name “Aquace® W104”. (Solids content, 30 min at 150° C.=40% by weight)
Crosslinking agent ARF-40® sold by Dongsung. (Solids content, 30 min at 150° C.=83.5% by weight)
Dply 165: solvent primer sold by Dongsung under the name “D-Ply® 165”. (Solids content, 30 min at 150° C.=10% by weight)
Crosslinking agent RFE®, sold by Bayer. (Solids content, 30 min at 150° C.=26.9% by weight)

### Adhesion Activator:

Borchi Kat22 from Borchers is a zinc carboxylate (organometallic).
Borchi Kat24 from Borchers is a bismuth carboxylate (organometallic).
Borchi KatVP244 from Borchers is a mixed zinc and bismuth carboxylate (organometallic).

### Adhesive:

W01: aqueous adhesive sold by Dongsung under the name “Aquace® W01”. (Solids content, 30 min at 150° C.=46.9% by weight)
Crosslinking agent ARF-40®, sold by Dongsung.
The tests were carried out using the following equipment:

press in A524 (WKD 029 set pressure maximum (indication 78.4 to 147.1 Pa (8 to 15 kg/cm²)));

Heraeus oven in A524 (FGE 138) set 70° C., ventilated;

punch ISO 34;

pneumatic press for cutting out test specimens.

### General Procedure for Joining:

The substrates (S1) and (S2) are sheets with dimensions 100×100×1 mm.

Preparation of the Substrate (S1)
Cleaning (in the comparative examples) or cleaning with adhesion activator (in the examples according to the invention) a smooth face of the substrate (S1) with a solvent or mixture of solvents comprising an adhesion activator;
Cleaning time: 10 to 30 s
drying at ambient temperature for 2 minutes (unless otherwise indicated);
applying the aqueous primer W104 (+5% crosslinking agent ARF-40®) with a brush;
drying at 70° C. for 5 minutes in a ventilated oven;
cooling for 2 minutes at ambient temperature;
applying the aqueous adhesive W01 (+5% crosslinking agent ARF-40®) with a brush;
drying: 5 minutes at 70° C. in a ventilated oven.

### Preparation of the Substrate (S2)

cleaning a smooth face of the substrate (S2) with the solvent MEK;
   Cleaning time 10 to 30 s.
drying at ambient temperature for 2 minutes;
applying the primer Dply 165 (+5% crosslinking agent RFE®) with a brush;
drying at 70° C. for 3 minutes in a ventilated oven;
cooling for 2 minutes at ambient temperature;
applying the aqueous adhesive W01 (+5% crosslinking agent ARF-40®) with a brush;
drying at 70° C. for 5 minutes in a ventilated oven.

TABLE 1

| | | | | Presence | | | |
|---|---|---|---|---|---|---|---|
| | | Cleaning | | of | | Peel | |
| | | solution | Drying | adhesion | | strength | |
| Comparative/Examples | S1 | (% by weight) | time | activator | S2 | (kg/cm) | Comments |
| Comparative Example 1 | 5533 | MEK | 2 min at | No | 7033 | 1 to 2 | Very |
| | | | 23° C. | | | | uneven |
| | | | | | | | adhesion |
| Comparative Example 2 | 5533 | n-butanol/ | 5 min at | No | 7033 | 7.5 | Even |
| | | 1,3-butanediol | 23° C. | | | 8.0 | adhesion |
| | | (70/30) | | | | | |
| Comparative Example 3 | 5533 | n-butanol/ | 7 min at | No | 7033 | <2 | |
| | | 1,3-butanediol | 50° C. | | | | |
| | | (70/30) | | | | | |
| Example 4 | 5533 | n-butanol/ | 7 min at | Yes | 7033 | 7.4 | |
| | | 1,3-butanediol | 50° C. | | | 9.8 | |
| | | (70/30) + | | | | 8.5 | |
| | | 2% dibutyltin | | | | 7.6 | |
| | | laurate (DBTL) | | | | 10.2 | |
| Example 5 | 5533 | n-butanol/ | 5 min at | Yes | 7033 | 7.6 | |
| | | 1,3-butanediol | 50° C. | | | 9.7 | |
| | | (70/30) + | | | | 8.0 | |
| | | 0.5% | | | | 9.8 | |
| | | dibutyltin | | | | | |
| | | laurate (DBTL) | | | | | |
| Comparative Example 6 | 5533 | n-butanol/ | 7 min at | No | 7033 | 1.2 | Very |
| | | 1,3-butanediol | 50° C. | | | 0.5 | uneven |
| | | (50/50) | | | | | adhesion |
| Example 7 | 5533 | n-butanol/ | 7 min at | Yes | 7033 | 4.2 | |
| | | 1,3-butanediol | 50° C. | | | 7.5 | |
| | | (50/50) + | | | | 8.7 | |
| | | 2% dibutyltin | | | | | |
| | | laurate (DBTL) | | | | | |
| Example 8 | 5533 | MEK + | 10 min | Yes | 7033 | 8.2 | |
| | | 2% Borchi | at 50° C. | | | 9.2 | |
| | | Kat22 | | | | 7.1 | |
| | | | | | | 8.5 | |
| | | | | | | 7.9 | |
| | | | | | | 7.5 | |
| Example 9 | 5533 | MEK + | 10 min | Yes | 7033 | 7.2 | |
| | | 2% Borchi | at 50° C. | | | 6.1 | |
| | | Kat24 | | | | 9.2 | |
| | | | | | | 5.7 | |
| | | | | | | 7.1 | |
| Example 10 | 5533 | MEK + | 10 min | Yes | 7033 | 6.9 | |
| | | 2% Borchi | at 50° C. | | | 7.1 | |
| | | KatVP244 | | | | 7.9 | |
| | | | | | | 7.3 | |
| Example 11 | 5533 | MEK + | 5 min at | Yes | 7033 | 8.9 | |
| | | 0.5% dibutyltin | 50° C. | | | 10.6 | |
| | | laurate (DBTL). | | | | | |
| Example 12 | 5533 | MEK + | 10 min | Yes | 7033 | 10 | |
| | | 0.5% dibutyltin | at 50° C. | | | 10.1 | |
| | | laurate (DBTL). | | | | | |
| Example 13 | 5533 | MEK + | 20 min | Yes | 7033 | 10.1 | |
| | | 0.5% dibutyltin | at 50° C. | | | 10.4 | |
| | | laurate (DBTL). | | | | 11.0 | |
| Example 14 | 5533 | MEK + | 5 min at | Yes | 7033 | 9.9 | |
| | | 2.0% dibutyltin | 50° C. | | | 9.8 | |
| | | laurate (DBTL). | | | | | |
| Example 15 | 5533 | MEK + | 10 min | Yes | 7033 | 8.8 | |
| | | 2.0% dibutyltin | at 50° C. | | | 9.0 | |
| | | laurate (DBTL). | | | | | |
| Example 16 | 5533 | MEK + | 20 min | Yes | 7033 | 8.2 | |
| | | 2.0% dibutyltin | at 50° C. | | | 9.1 | |
| | | laurate (DBTL). | | | | 9.7 | |

1. A composite polymeric structure comprising in order and adhering to the adjoining layer(s):
(i) a substrate (S1) comprising at least one polymer;
(ii) an adhesion activator (A) in direct contact with said substrate (S1) at an adhesive bonding surface (F1) of said substrate (S1); wherein said adhesion activator is selected to react with the functional groups of at least one polymer in said substrate (S1) or to complex the chains of at least one polymer of said substrate (S1) at said adhesive-bonding surface (F1) of said substrate (S1);
(iii) an adhesive (C); and
(iv) a second substrate (S2), wherein said polymer of said substrate (S1) is selected from the group consisting of: thermoplastic elastomer (TPE) polymers, which comprise a chain formed of an alternation of hard segments and of soft segments; and polyamides homopolymers or copolymers; and wherein said substrates (S1) and (S2) can be the same or different and are not silicones.

2. The composite according to claim 1, wherein the adhesion activator (A) is chosen from the catalysts which play a role in chemical reactions involving isocyanate functional groups.

3. The composite according to claim 1, wherein the adhesion activator (A) is chosen from catalysts of amine type, of metal salt type, of organometallic type and mixtures thereof.

4. The composite according to claim 1, wherein the substrate (S2) is of the same nature as the substrate (S1).

5. The composite according to claim 1, wherein the substrate (S1) and the substrate (S2) are different in nature, such that (S2) is selected from the group consisting of (TPEs), polyolefins, polyamines, polyesters, polyethers, polyesterethers, polyimides, polycarbonates, phenolic resins, crosslinked or uncrosslinked polyurethanes, polyurethane foams, poly(ethylene/vinyl acetates), natural or synthetic elastomers, polybutadienes, polyisoprenes, styrene/butadiene/styrenes (SBSs), styrene/butadiene/acrylonitriles (SBNs), polyacrylonitriles, natural or synthetic fabrics, fabrics made of organic polymer fibres, fabrics made of fibers of polypropylene, polyethylene, polyester, polyvinyl alcohol, polyvinyl acetate, polyvinyl chloride, polyamide, fabrics made of glass fibres or of carbon fibres, and leather, paper; and board.

6. The composite according to claim 1, wherein the substrate (S1) is chosen from (a) copolymers having polyester blocks and polyether blocks, (b) copolymers having polyurethane blocks and polyether blocks, (c) copolymers having polyamide blocks and polyether blocks, and mixtures thereof.

7. Process for the surface treatment of a substrate (S1) made of thermoplastic elastomer (TPE) polymer or of polyamide homopolymer or copolymer in order to promote the attachment of a primer (P) and/or an adhesive (C) for the purpose of the adhesive joining of said substrate (S1) to another substrate (S2), comprising applying an adhesion activator (A) to a substrate (S1) at an adhesive-bonding surface and adhesively joining said substrate (S1) having thereon an adhesion activator to substrate (S2).

8. Process according to claim 7, wherein the adhesion activator (A), alone or as a mixture with a degreasing solvent and/or included in an organic solvent-based or aqueous-based adhesion primer (P) and/or included in an adhesive (C), is applied to the adhesive-bonding surface (F1) of the substrate (S1) for the purpose of the adhesive joining of said substrate (S1) to another substrate (S2).

9. (canceled)

10. (canceled)

11. The composite polymeric substrate of claim 1 comprising a shoe sole.
